(19) United States
(12) Patent Application Publication
(10) Pub. No.: US 2024/0055956 A1
(43) Pub. Date: Feb. 15, 2024

(54) BRUSHLESS ELECTRIC MOTOR

(71) Applicant: Hella GmbH & Co. KGaA, Lippstadt (DE)

(72) Inventors: Daniel Noelkel, Lippstadt (DE); Katrin Zimmermann, Soest (DE)

(21) Appl. No.: 18/496,365

(22) Filed: Oct. 27, 2023

Related U.S. Application Data
(63) Continuation of application No. PCT/EP22/60522, filed on Apr. 21, 2022.

(30) Foreign Application Priority Data
May 4, 2021 (DE) 10 2021 111 449.7

(51) Int. Cl. H02K 11/215

(52) U.S. Cl. CPC H02K 11/215; H02K 2211/03; H02K 2203/03

(57) ABSTRACT

A brushless electric motor is provided, and includes a stator with numerous electromagnets, each of which is formed by an iron core and a wire coil. A rotor that rotates in the stator is also provided, and which has a multi-pole circular magnet or numerous permanent magnets. A printed circuit board is populated with electric and/or electronic components and a connection for electrically connecting the stator to the printed circuit board. The connection includes contacts connected to the stator, which can be electrically connected to the printed circuit board. The contacts are attached to an outer circumference of the stator.

### CROSS REFERENCE TO RELATED APPLICATIONS

This application claims priority to PCT Application No. PCT/EP2022/060522, filed Apr. 21, 2022, which itself claims priority to Germany Application No. 10 2021 111 449.7, filed May 4, 2021, the entireties of both of which are hereby incorporated by reference.

### FIELD OF THE INVENTION

The invention relates to a brushless electric motor comprising a stator with numerous electromagnets, a rotor that can rotate in the stator, which has a multi-pole circular magnet or numerous permanent magnets, a printed circuit board that is populated with electric and/or electronic components and means for electrically connecting the stator to the printed circuit board, with contacts connected to the stator that can be electrically connected to the printed circuit board.

### BACKGROUND OF THE INVENTION

These electric motors are known per se and used for numerous purposes in motor vehicles, e.g. as servomotors.

An electric motor of this type is described in DE 10 2016 226 200 A1, which is used to power an oil pump in a motor vehicle. The electric motor comprises a stator and a rotor that can rotate therein, in which the wire coils for all of the electromagnets in the stator are formed by a single, continuous wire. This results in a motor that is just as powerful as larger motors, which can be produced more economically.

An electric motor is disclosed in DE 10 2017 222 076 A1 that can be electrically connected using insulation-piercing contacts. These are located in plug-in sockets. To ensure that there is reliable contact between the wire and the insulation-piercing contact, clamping contours are formed on the walls of the plug-in sockets.

A disadvantage with existing electric motors is that a small spacing between the stator and the printed circuit board is relatively large because of the contacts to the electromagnets, resulting in a relatively tall motor that occupies a lot of space.

### BRIEF SUMMARY OF THE INVENTION

The object of the invention is therefore to create an electric motor with a more compact design. In particular, the space between the stator and the printed circuit board should be small.

In an example embodiment, contacts to the electromagnets are attached to an outer circumference of the stator. This results in a minimum spacing between the printed circuit board and the stator and the contacts thereon. This allows for the contacts to be placed axially deeper in the stator, such that the bearing surfaces (contact surfaces) formed by the contacts are closer to the upper surface of the stator in which they are formed. This surface is formed by the upper surface of the stator.

The overall height of the electric motor is reduced, thus reducing the necessary installation space. Furthermore, the distance between the transmitter and receiver in the sensor is reduced, resulting in greater precision and a minimizing of measurement error. The reduction in the height is about 3 mm. The depth of the sockets containing the contacts is limited by the iron in the stator. It is also impossible to make the contacts any smaller, because the contacts and connections would no longer be reliable.

Furthermore, the contacts on the outer circumference of the stator can be formed by sockets or by coating the contacts.

The dependent claims relate to advantageous embodiments of the invention.

In one embodiment, the electric motor contains a sensor for determining a rotational angle and/or rotations of the rotor. The electric motor can consequently be used effectively as a servomotor.

The sensor can be a Hall sensor. These sensors are inexpensive and simple, and have proven to be reliable. The small spacing between the rotor and the printed circuit board makes it possible to use inexpensive SMD Hall sensors.

In another embodiment, the contacts are insulation-piercing contacts. These simplify assembly.

In another embodiment, there are sockets for the contacts on the outer circumference of the stator. The sockets make it easy to quickly assemble the contacts.

In another embodiment, the sockets extend radially outward from the stator. This ensures a sufficient spacing between the contacts and the stator.

In another embodiment, there are press-in contacts for electrically connecting the contacts to the printed circuit board. This simplifies assembly of the electric motor.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 shows a side view of an electric motor with a printed circuit board.

FIG. 2 shows a top view of the electric motor, without the printed circuit board.

FIG. 3 shows a rotated side view of the electric motor from FIG. 1, partially cut away.

### DETAILED DESCRIPTION OF THE DRAWING

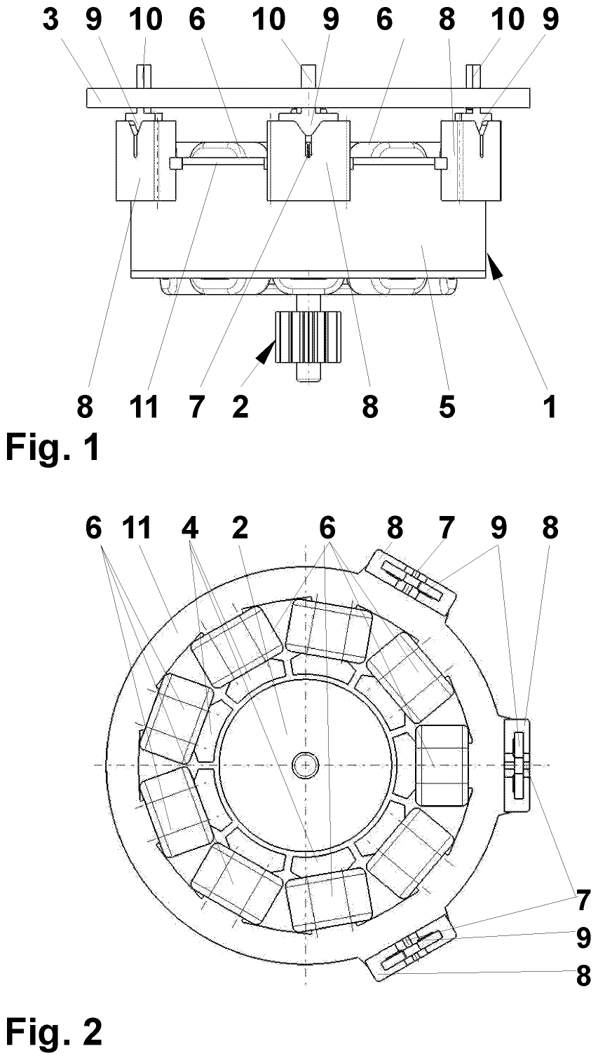

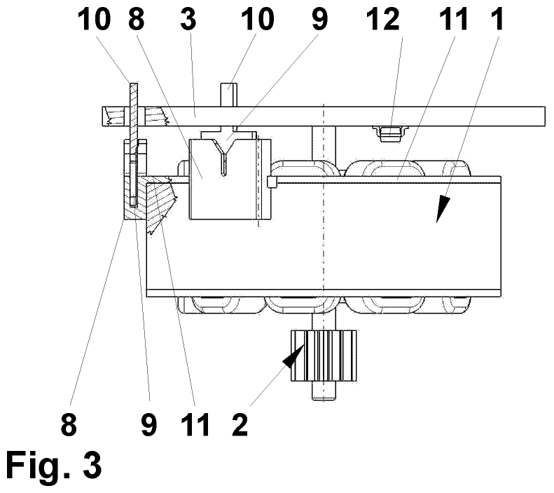

As can be seen in FIGS. 1 to 3, a brushless motor comprises a stator 1, rotor 2, and printed circuit board 3. The electric motor is a DC motor.

The stator 1 comprises numerous N×3 (where N is a whole number) iron cores 4, which face radially inward from the inside of a circular ring 5. The nine iron cores 4 shown here are identical, each of which is surrounded by a separate wire coil 6 to generate a magnetic field. The coils 6 are supplied with a three-phase current when in operation, which is controlled and/or regulated by a control circuit. The three wires 7 forming the wire coils 6 are inserted into three sockets 8 to establish contact, each of which enters its dedicated socket 8 separately and is connected to a contact 9, specifically an insulation-piercing contact 9. Each of the insulation-piercing contacts 9 has a press-in contact 10 on its upper end, facing away from the socket 8.

Instead of the insulation-piercing contacts 9, the contacts can be formed with different connections, e.g. resistance welding or soldering.

Instead of the press-in contacts 10, other means for establishing contact to the printed circuit board can also be used, e.g. terminals or soldering lugs.

According to the invention, the contacts, in this case the sockets 8 and therefore the insulation-piercing contacts 9, are attached to the outer circumference of the stator 1. A circular washer-shaped plastic cover 11 is formed on the stator 1 for this, from which the sockets 8 protrude radially outward from the outer circumference of the stator 1, instead of from its upper surface facing away from the stator 1 in the conventional manner. The sockets 8 are snug against the stator 1, with their openings facing upward. Attachment flaps can be formed on the plastic cover 11 for attaching the electric motor. The plastic cover 11 is formed along with the sockets 8 and the attachment flaps as a single piece made of plastic, e.g. in an injection molding process. First ends of the wires 7 are each inserted into a dedicated socket 8. Second ends of the wires 7 are connected on the inside of the stator.

The rotor 2 can rotate inside the stator 1, and has a multi-pole permanent magnet. The rotor 2 can be supported on an axle in the housing (not shown).

The printed circuit board 3 has an electric circuit for the wire coils 6 with which the electromagnets in the stator 1 are activated. At least one Hall sensor 12 is also attached to a lower surface of the printed circuit board 3 facing the stator 1, which has a dedicated electronic evaluation unit. The Hall sensor 12 is placed such that the permanent magnets can act on it. This means that the Hall sensor 12 is as close as possible to the permanent magnets, thus ensuring that the sensor 12 will function properly and precisely, while still resulting in an inexpensive production of the electric motor.

### LIST OF REFERENCE SYMBOLS

1 stator
2 rotor
3 printed circuit board
4 iron core
5 ring
6 wire coil
7 wire
8 socket
9 insulation-piercing contact
10 press-in contact
11 plastic cover
12 Hall sensor

We claim:

1. A brushless electric motor comprising:
a stator with one or more electromagnets, each of which is formed by an iron core and a wire coil,
a rotor that rotates in the stator, and which has a circular multi-pole magnet or one or more permanent magnets,
a printed circuit board populated with electric and/or electronic components and a connection for electrically connecting the stator to the printed circuit board, the connection including contacts attached to the stator, which can be electrically connected to the printed circuit board,
wherein the contacts are attached to an outer circumference of the stator.

2. The electric motor according to claim 1, further including a sensor for determining a rotational angle and/or rotations of the rotor.

3. The electric motor according to claim 2, wherein the sensor comprises at least one Hall sensor.

4. The electric motor according to claim 1, wherein the contacts are insulation-piercing contacts.

5. The electric motor according to claim 1, wherein the contacts have sockets on an outer circumference of the stator.

6. The electric motor according to claim 5, wherein the sockets extend radially outward from the stator.

7. The electric motor according to claim 1, further including press-in contacts for electrically connecting the contacts to the printed circuit board.
